(19) United States
(12) Patent Application Publication
(10) Pub. No.: US 2013/0282902 A1
(43) Pub. Date: Oct. 24, 2013

(54) COMPUTER NETWORK NODE DISCOVERY SEQUENCING

(71) Applicant: German Eichberger, San Diego, CA (US)

(72) Inventor: German Eichberger, San Diego, CA (US)

(21) Appl. No.: 13/994,820

(22) PCT Filed: Jan. 9, 2011
(86) PCT No.: PCT/US2011/020618

§ 371 Date: Jun. 17, 2013

(51) Int. Cl. H04L 12/26

(52) U.S. Cl. CPC H04L 43/04
USPC 709/224

(57) ABSTRACT

A computer network node discovery process (120; 300) provides for transmitting discovery probes (130; 211) in their order in a sequence (114; 219) of probes (130; 211) to each of plural network addresses. In the course of discovery, the sequence is updated (122; 308) based on results (132; 228) returned in response to probes transmitted to previously probed network addresses.

### BACKGROUND

Managing a computer network can involve maintaining an inventory of network nodes, which, in large installations, may number in the thousands and include a variety of types. For example, nodes can: be hardware or software based, be appliances or general-purpose computers, have or run on different processor architectures, and run different operating systems. Several standardized and structured protocols are available including Simple Network Management Protocol (SNMP), WS-BEM, and Microsoft's CIM for inventory purposes, but are often blocked (by firewalls or by disabling those capabilities at the nodes) for security purposes. In such cases, discovery may be limited to probing over command-response connections such as Secure Shell (SSH).

A SSH (or SSH-2) connection provides a command line interface for communicating with target nodes. The commands that can be recognized may be target dependent. For example, different commands may be needed to probe network nodes running different operating; systems. In the context of discovery, the operating system (which may be an operating system run from firmware or RAM) or the device type may not be known. Accordingly, a discovery node ma transmit commands for different operating systems until a response is received identifying; the operating system or other aspect of the node type.

### BRIEF DESCRIPTION OF THE DRAWINGS

FIG. 1 is a schematic diagram of a system in accordance with an embodiment.

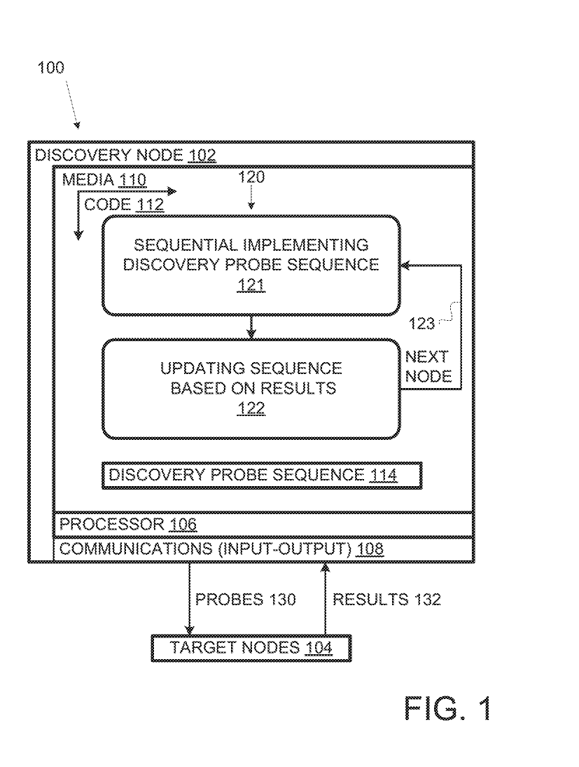

FIG. 2 is a schematic diagram of a system in accordance with another embodiment.

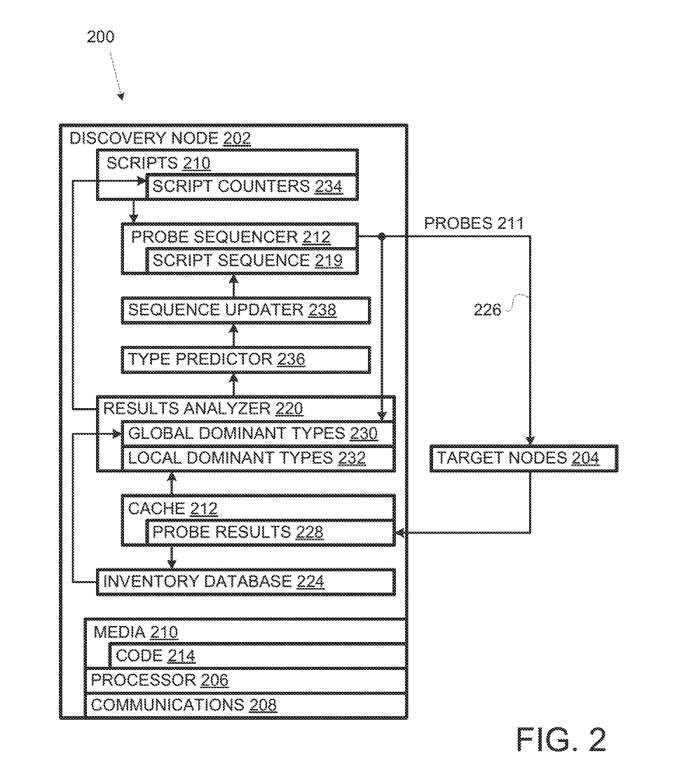

FIG. 3 is a flow chart of a process implemented by the system of FIG. 2.

### DETAILED DESCRIPTION

A discovery node provides for adaptive discovery in which an to order in which discovery probes are transmitted to network addresses adapts as discovery data is obtained to minimize penalties due to probe “misses”. A probe miss occurs when a probe yields no response, e.g., as may occur when a target node of one type does not understand a probe designed for a different node type. In that case, there is a penalty in that time and bandwidth have been consumed while the desired information is not returned. Moreover, an SSH connection may be broken in the case of a failed probe. In such a case, further time and bandwidth may be consumed reestablishing an SSH connection so that subsequent discovery probes can be made.

In computer network system 100, a discovery node 102 determines the identities, types, and configurations of target nodes 104. To this end, discovery node 102 includes a processor 106, communications devices 108, and computer-readable storage media 110 encoded with code 112. Code 112 defines a discovery probe sequence 114 and a computer network node discovery process 120.

At process segment 121, discovery node 102 sequentially implements discovery probe sequence 112 of probes 130 until the desired data (indicating a node type or the fact that there is no node at a network address) is obtained for a target node. At process segment 112, discovery probe sequence 112 is updated based at least in part on prior probe results 132 for use in the next iteration of process segment 121 as indicated at 123. By iteratively updating discovery probe sequence 114, the likelihood of probe hits increases and the likelihoods of misses (including those involving disconnections) decrease. As a result, discovery consumes less time and less communications bandwidth. Similar benefits accrue in the following embodiment.

A computer network system 200 includes a discovery node 202 for conducting discovery of target nodes 204. Discovery node 202 includes a processor 206, communications devices 208, and computer-readable storage media 210, including a cache 212. Media 210 is encoded with code 214 which represents programs and data including scripts 216, script sequencer 218, results analyzer 220, probe results 228, inventory database 224, type predictor 236, and sequence updater 238.

The number and types of target nodes 204 may be initially unknown or initially partially known. In particular, nodes may employ different processor architectures and run a variety of operating systems including various forms of Unix, e.g., Linux, AIX, HP-UX, and other forms for specialized devices such Cisco and other network infrastructure devices, specialized “appliance” computers, such as a IBM Host Management Computer (HMG), mobile devices, sensors, integrated Lights-Out devices (to power a device on and off) and any device which can be connected to using a command-line communication technology such as SSH. In other embodiments, probes may be registered for obtaining values for other characteristics of a target node. In cases where partial inventory information is available, it may be used to predict types for network addresses for which such information is unavailable. In other cases, results obtained during discovery may be used during the same discovery session to predict the types of nodes that may occupy certain network addresses.

Scripts 210 include scripts for generating probes 211 adapted for each of the possible target node types. Probe sequencer 212 determines a current Internet Protocol (IP) network address to probe and determines an order in which scripts 210 are executed over an SSH connection 226 so that probes are transmitted to the selected address. For example, script sequencer 218 might initially send scripts for target nodes running AIX operating system instances before sending scripts for target nodes running HP-UX operating system instances. If the AIX discovery commands result in misses, the HP-UX scripts are executed. If the HP-UX commands result in hits, scripts designed for other operating systems, e.g., Linux, may be omitted. Probe results 228 may be stored in results cache 212 (to be input into inventory database 224 when the discovery session is completed).

Results analyzer 220 analyzes probe results 228 to determine overall dominant target node types 230 and local (e.g., based on IP addresses) dominant target node types 232. For example, an enterprise network may have subnetworks that belong to different departments that may make independent purchasing decisions. As a result, one node type may dominate within a department's subnet while another node type may dominate globally, e.g., company-wide, Type predictor 236 may take both global and local dominance into account in generating predictions for a next target node to be probed. This prediction can be used by sequence updater 238 as at least a partial basis for updating script sequence 219, which determines a probe sequence to be output by probe sequencer 232.

For example, assume script sequence 219 includes a Unix probe followed by an HP-UX probe. If the first target node turns out to be running HP-UX, then results analyzer 220 will consider a HP-UX type to be dominant. The next target node to be probed will be predicted to be an HP-UX node and script sequence 219 will be updated so that HP-UX scripts precede rather than follow Linux scripts. Further assume that the results returned in response to further probes conform to a type distribution of 70% HP-UX, 20% Linux, and 10% other. In that case, the script order in sequence 219 will generally include HP-UX scripts first, Linux scripts second, followed by scripts for other types.

However, for example, if IP addresses 15.178.179.55 and 15.178.179.57 are both Linux devices as indicated by previous probe results), then the probability is high that 15.178.179.56 is a Linux device. This is an example of local dominance. In such a case, the target node having IP address 15.178.179.56 would be predicted to be a Linux type node and a Linux script would precede script for globally dominant HP-UX devices for this particular target node. However, if only one immediate neighbor were a Linux device, the degree of global dominance of HP-UX would be considered in determining whether the first script should be a Linux script or an script.

A sequence can include scripts or portions of scripts that are executed only on condition of a hit by a previous probe. For example, if a Linux probe discovers a Linux type node, a further probe can be used to determine whether the Linux type node is an IBM Host Management Console (HMC) node or a general-purpose node. However, the HMC probe can be skipped if the Linux probe results in a miss.

The weightings assigned to global and local dominance can vary depending on script performance, which is determined by associating each script transmitted with its results. The results may be tracked using counters 234 included in for otherwise associated with) the respective scripts 212. For example, a script counter may be incremented each time a hit results, decremented each time a disconnection occurs, and left unchanged for misses that do not involve disconnections. Disconnections are expensive events, so scripts resulting in disconnections can be presented later in a script sequence than they would be otherwise. This will tend to favor earlier placement in the discovery sequence for more robust scripts.

In the event of a disconnect, the previously obtained discovery data is retained in the discovery cache so that discovery can continue with the next probe in the sequence and does not need to run the same commands again. Also, a script may register for specific previous outputs to allow scripts to be modularized, further minimizing the execution of duplicate probes due to disconnects.

In alternative embodiments, script performance data may be maintained in a database rather than or in addition to within the scripts themselves. Also, the scoring of hits, misses, and disconnects may allow different magnitudes for the rewards and penalties associated with hits, misses, and disconnects. For example, the magnitude of a disconnect penalty may or may not be equal and opposite to the reward for a hit. Also, a penalty (e.g., smaller than that assigned to a disconnect but greater than zero) can be assigned to a miss.

In an environment in which continuous network addresses tend to be assigned to nodes of the same type, the weightings will trend to favor local dominance. On the other hand, in an environment in which network addresses are randomly assigned, the script sequence will trend toward weighting global dominance more heavily. If the types of the immediate neighbors are unknown or if they are different, global rather than local dominance to determines the script sequence.

In the foregoing, determinations of local dominance consider only immediate network address neighbors. However, broader network address ranges can be considered as well. In some embodiments, global and local dominance are treated as extremes on a continuum, with each prediction taking into account address distance for each probe result in predicting a target node type. Predictions can be of a solitary type or involve probability distributions of different types.

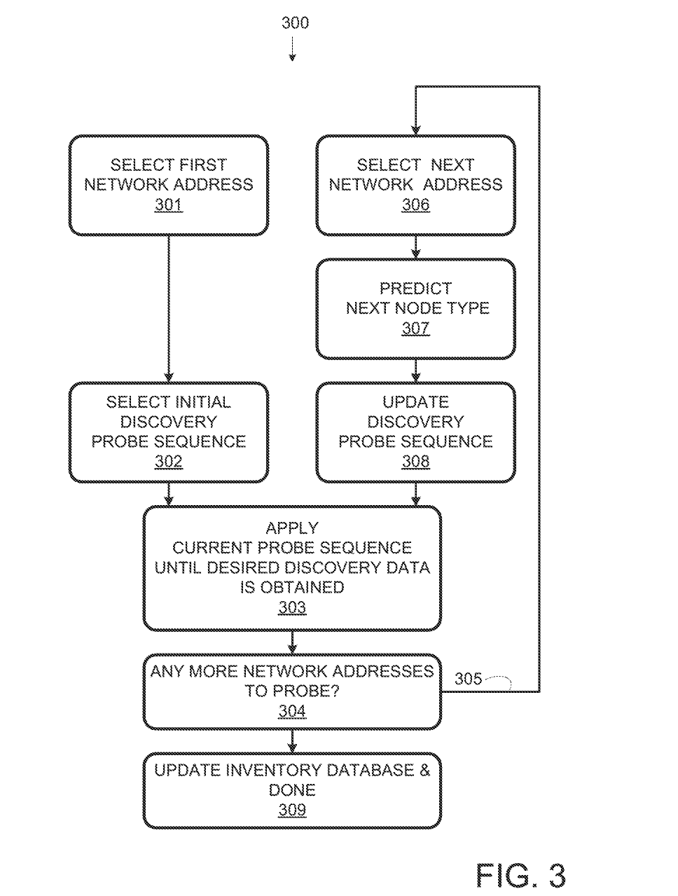

Computer network system 200 employs a process 300, flow charted in FIG. 3. At process segment 301, a first network address is selected as a probe target. At process segment 302, a script sequence, and thus a probe sequence, is selected in an initial form. The selection can be based on values already in database 224 from previous discovery sessions, a sequence used in a previous discovery session, or a default discovery sequence.

At process segment 303, the first probe sequence is applied one script at a time until the desired discovery data is obtained for the target network address or until all scripts in the sequence have been applied. Script performance can be tracked at process segment 303, e.g., by incrementing and decrementing script counters. At process segment 304, a determination is made whether there are any more network addresses to be proved. In general, there will be at least a second network address; in that case, loop 305 is entered and a next target network address is selected at process segment 306.

At process segment 307, a prediction of a type for the next node is made. The prediction can be in the form of a single node to type or in the form of a node-type probability distribution. At process segment 308, the initial discovery sequence may be updated based on the prediction. Of course, if the current discovery sequence matches the prediction, the sequence may be left unchanged in the current iteration of process segment 308.

At process segment 303 the current sequence is applied until the desired data is obtained. The desired data might indicate the identity and type of a node or indicate that there is no node at the probed network address (e.g., upon completion of a sequence without any responses). At process segment 304, a determination is made if there are any more target node addresses to probe. Loop 305, which consists of process segments 305-308, 303, and 304, is iterated until it is determined at process segment 304 that all network addresses to be probed have been probed. In that case, at process segment 309, the inventory database is updated with discovery data and process 300 is done.

Herein, a “system” is a set of interacting non-transitory tangible elements, wherein the elements can be, by way of example and not of limitation, mechanical components, electrical elements, atoms, physical encodings of instructions, and process segments, Herein, “process” refers to a sequence of actions resulting in or involving a physical transformation. “Storage medium” and “storage media” refer a system including non-transitory tangible material in or on which information is or can be encoded so as to be readable by a computer. “Display medium” and “display media” refer to storage media in which information is encoded in human readable form. “Computer-readable” refers to storage media in which information is encoded in computer-readable form.

Herein, unless preceded by the word “virtual”, “machine”, “device”, and “computer” refer to hardware or a combination of hardware and software. A “virtual” machine, device or computer is a software analog or representation of a machine, device, or server, respectively, and not a “real” machine, device, or computer. A “server” is a real (hardware or combination of hardware and software) or virtual computer that provides services to computers. Herein, unless otherwise apparent from context, a functionally defined component (e.g., a results analyzer, a type predictor, a sequence updater, or a probe sequencer) of a computer is a combination of hardware and software executing on that hardware to provide the defined functionality. However, in the context of code encoded on computer readable storage media, a functionally-defined component can refer to software.

Herein, a computer is a machine having co-located or distributed components including computer-readable storage media, a processor, and one or more communications devices. The media stores or is configured to store code representing data including computer-executable instructions. The processor, which can include one or more central-processing units (CPUs), reacts and manipulates data in accordance with the instructions. “Communication(s) device(s)” refers to computer-hosted devices used to transmit or receive data. Herein, a “computer network” is a network of communicatively coupled real and, in some cases, virtual nodes, wherein the nodes can be, by way of example and not of limitation, servers, network infrastructure devices, and peripherals. Herein, a “node” encompasses real and virtual devices.

In this specification, related art is discussed for expository purposes. Related art labeled “prior art”, if any, is admitted prior art. Related art not labeled “prior art” is not admitted prior art. In the claims, “said” qualifies elements for which there is explicit antecedent basis in the claims; “the” refers to elements for which there is implicit antecedent basis in the claims; for example, the phrase “the center of said circle” indicates that the claims provide explicit antecedent basis for “circle”, which also provides as implicit antecedent basis for “center” since every circle contains exactly one center. The illustrated and other described embodiments, as well as modifications thereto and variations thereupon are within the scope of the following claims.

What is claimed is:

1. A computer network node discovery process (120; 300) comprising:
iteratively, for each of plural network addresses, sequentially implementing (121; 303) a discovery probe sequence (114; 219) by transmitting probes (130; 211) until desired discovery data is obtained from a target node (104; 204); and
updating (122; 308) said sequence based at least in part on prior results (132; 228) of probes transmitted to network addresses during previous iterations.

2. A process as recited in claim 1 wherein said updating involves changing the order of probes in said sequence.

3. A process as recited in claim 1 wherein said probes are managed by scripts (210), and said updating said sequence involves changing an order in which said scripts are executed.

4. A process as recited in claim 3 wherein said scripts include counters (234) that are incremented when a probe managed by a scripts results in a hit and that are decremented when a probe managed by a script results in a disconnection.

5. A process as recited in claim 1 further comprising predicting (330) a node type for a selected IP address based on said prior results, said updating being based at least in part on the prediction.

6. A system (200) comprising:
a probe sequencer (212) configured to transmit discovery probes (211) to target computer-network addresses so that, for each network address, said probes are transmitted in an order specified by a probe sequence (219); and
a sequence updater (238) configured to update said probe sequence so that the order in which probes are transmitted to subsequent network addresses are determined at least in part based on probe results (228) returned in response to probes transmitted to previously probed network addresses.

7. A system as recited in claim 6 further comprising a type predictor (236) for making predictions regarding node types at network addresses based at least in part on results of previously transmitted probes, said sequence updater updating said probe sequence based at least in part on said predictions.

8. A system as recited in claim 7 further comprising a results analyzer (220) configured to determine dominant node types based on said results, said predictions being based on dominant node type determinations.

9. A system as recited in claim 6 wherein said probes are controlled by scripts (210), said probe sequencer controlling the order in which said probes are transmitted by controlling the order in which said scripts are executed.

10. A system as recited in claim 6 wherein said scripts include respective counters (234) that are incremented and decremented depending on the outcomes of probes transmitted when the scripts are executed.

11. A system (100; 200) comprising computer-readable storage media (110; 210) encoded with code (112; 212) defining data and instructions, said instructions being configured to, when executed by a processor (106; 206):
transmit (121; 303) discovery probes (130; 211) to a series of computer network addresses to obtain discovery data relating to nodes associated with those addresses, the transmitting for each of said addresses involving transmitting probes from a sequence of probes associated with different respective node types until desired discovery data is obtained; and
update (122; 308) said sequence so that the order of probes in said sequence as applied, to probes transmitted to network addresses later in said series is changed relative to the order of said sequence as applied to network addresses earlier in said series based on probe results (132; 228) of transmitted probes.

12. A system as recited in claim 11 further comprising said processor.

13. A system as recited in claim 11 wherein said probes are transmitted by executing respective scripts, said sequence being updated by changing the order of scripts used to transmit said probes.

14. A system as recited in claim 13 wherein said instructions are further configured to increment and decrement counters (234) associated with said scripts based on the results or lack thereof of probes transmitted by executing said scripts.

15. A system as recited in claim 13 wherein each of said scripts is adapted to send probes designed to elicit a response from a node running a respective operating system so that different scripts elicit responses from different operating systems.
